(19) United States
(12) Patent Application Publication
(10) Pub. No.: US 2011/0278997 A1
(43) Pub. Date: Nov. 17, 2011

(54) Modular containment system

(76) Inventors: Julian Wilkins, Bridgewater, NJ (US); Stephanie A. Wilkins, Bridgewater, NJ (US)

(21) Appl. No.: 12/800,431

(22) Filed: May 15, 2010

(51) Int. Cl. B25J 21/02

(52) U.S. Cl. 312/1

(57) ABSTRACT

Modular containment system having at least one shell having at least one shell panel whereby an operator is able to manipulate equipment contained in a isolated environment, and at least one end panel. The at least one shell and at least one end panel are able to be configurably and removably connected together. When connected together, the at least one shell and at least one end panel form a closed housing. A pressure differential can be created between the inside of the housing and outside the housing, thereby forming an isolated process environment.

The present application is directed towards a modular containment system. More specifically, the present invention provides a flexible containment system or isolator that can be configured according to equipment need.

Isolators have been known since the origin of glove boxes for containment in the nuclear industry. They have since grown to be used in a variety of applications and industries, including the food industry, hospitals, animal laboratories and the pharmaceutical arena. Pharmaceutical applications include keg sampling, weighing and dispensing, crystallization, micronizing, blending, granulation, drying, tablet compression, tablet coating, sterile liquid operations, and aseptic filling, access and handling, as well as other applications. Isolators enable operators to be separated from these operations, and thereby avoid contamination. Conversely, isolators provide physical isolation of manufactured products from the background environment (i.e., the room outside the isolator).

Isolators are designed according to production need. Because of the variety of manufacturing specifications required for the applications that isolators serve, their costs can be expensive. For example, these isolators can have systems for sterilization and decontamination, as well as complicated systems for micro-filtration of the air exchanged with the outside. Further, because a manufacturing facility may have multiple processing requirements, more than one type of isolator may be required for the processes served.

Accordingly, there is a need for a cost-effective means for containing hazardous and toxic material. Further, there is a need for a containment system having the flexibility to adapt to various process needs, particularly in development and clinical phases.

### SUMMARY OF THE INVENTION

The present invention provides for a modular containment system having interchangeable panels that can be adapted for isolating various process equipment according to manufacturing demands. The modular containment system has either at least two shells in a back-to-back arrangement together with at least two end panels, or a combination of at least one shell, at least one frame, at least one baffle plate and at least two end panels, whereby an operator is able to manipulate equipment contained in an isolated environment. The shells, frames, plates and end panels can be configurably and removably connected together in multiple arrangements, depending on processing needs. When connected together, the combination of at least two shells and at least two end panels, or the combination of at least one shell, at least one frame, at least one plate and at least two end panels form a closed housing. A pressure differential can be created between the inside of the housing and outside the housing, thereby forming an isolated process environment.

As noted above, the modular containment system can also include a frame and at least one baffle plate able to be configurably and removably connected to the shell and end panel. This baffle plate is able to be configured with process equipment thereon for use within the isolated process environment.

Both the shell and end panel can have one or more glove ports. Further, the end panel and/or the baffle plate can have process equipment mounted thereon.

The modular containment system can also include an air handling module for regulating pressure within the modular containment system, thereby creating a pressure differential. In one embodiment, pressure inside the closed housing is from about −25 pa to about −100 pa.

The sizes of the shell, end panel, frame and baffle plates can vary. For example, the shell and end panel can be single, double or triple height, with each height having a panel for manipulating equipment within the isolated process environment.

The shell can be removably connected to a second shell in a side-by-side or back-to-back arrangement. The back-to-back (or end-to-end) arrangement results in a double-sided isolator. End panels for a double-sided isolator can be double-sized. The double-sided isolator can be a single, double or triple height isolator. Further, when the shell is removably connected to a second shell in a side-by-side arrangement, the shells can be of the same height or of differing heights.

In one embodiment, the modular containment system can handle Class II dusts. In another embodiment, the containment system can provide a nitrogen inert environment.

The modular containment system can be removably and air sealably connected to any isolator having a connectable interface.

### BRIEF DESCRIPTION OF THE DRAWINGS

FIG. 1 is a front perspective of one embodiment of a modular containment system according to the present invention illustrating four units joined together in modular fashion.

FIG. 2 is an exploded front perspective of another embodiment of a modular containment system illustrating a triple-height double sided containment system inline with an air controller unit.

FIG. 3 is an exploded front perspective of another embodiment of a modular containment system illustrating a single-height single sided containment system.

FIG. 4 is an exploded view of a rear panel and frame for configuration with a single-sided unit.

FIG. 5 is an exploded front perspective of another embodiment of a modular containment system illustrating a triple-height single sided containment system with a separate rear panel for each level of the unit.

FIG. 6 is an exploded front perspective of another embodiment of a modular containment system illustrating two triple-height single sided units joined side-by-side with a single rear panel for both units.

FIG. 7 is a side plan view of a triple-height, double end panel with a press mounted on a cart.

FIG. 8 is a front plan view of a triple-height containment system with a press contained therein.

FIG. 9 is a side plan view of a triple-height double sided containment system with process equipment contained therein and gull wing access panels open for access and setup.

FIG. 10 is a left side plan view of a triple-height single sided containment system with process equipment mounted therein.

FIG. 11 is a front plan view of three triple-height single sided containment system joined side-to-side to form a single unit with process equipment mounted therein.

FIG. 12 is top plan view of the containment system of FIG. 11 illustrating the process equipment mounted thereon to the baffle plates.

FIG. 13 is a right side plan view of the containment system of FIG. 11 with gull wing access panel open for access.

FIGS. 14a-14s are front and side plan views of various shell configurations.

FIG. 15 is a cross-sectional view of a casing for process equipment (e.g., a granulator) as mounted on a ventilated shelving and baffle plate.

In keeping with the present invention, the modular containment system is a highly flexible system that can be configured according to process or manufacturing needs. Accordingly, the containment system can be designed to isolate a variety of equipment with great flexibility and occupational control of exposure. Further, the containment system is able to connect in a contained, reconnectable and sealable manner with conventional isolators having the same connection method or technique.

The containment system includes front panels or shells that can be configured in a variety of ways. The illustrated shell is triple height with a lower side-hinged two-glove openable vision manipulation panel and an upper level fixed vision manipulation panel with two glove ports. However, it should be understood that the shells are not limited to this configuration, but rather can be configured in a variety of ways.

The containment system further includes back panels or frames for mating with the front shells to form a single-sided isolator. The back panel includes baffle plates that enable equipment mounted with the baffle plates to dock with the back panel in a modular and interchangeable way.

In addition to the front and back panels, the containment system further includes end panels for closing off the containment system and forming the isolator. These end panels can be either single-sided or, if desired to mate with other containment systems, the end panels can be double-sided. In this manner, a series of equipment can be isolated and connected together.

The containment system can also include adjustable-height trolleys or carts for supporting or carrying process equipment. These trolleys can be adapted to run on tracks built into the shell base.

The containment system is not limited with respect to the equipment that can be mounted on the baffle plates or carts. Examples of equipment that can be isolated include blenders, granulators, presses, Fitz mills, jet mills and roller compactors, among others. The equipment can be set on the table, or mounted on a panel such as the back panel or end panel.

In order for the containment system to isolate the products processed therein, the system can further includes air handling units.

For the containment system to keep its inside environment separate from the outside environment and thereby avoid contamination, the connection between each panel and shell should be dust tight and leak tight with respect to air. In this regard, high levels of ‘leak tightness’ is not required. However, the containment system should be able to sustain a pressure differential between the interior of the system and the outside air without difficulty. At the same time, the panels should be simple to connect and maintain, particularly with respect to the seals.

There are a variety of ways to design the shells so that they are dust tight and leak tight when connected together. In one non-limiting embodiment, structural elements along the lines of the shells where they are joined together are pressed to the required profile and joined to the shell by welding or other means. Gaskets can then be utilized along the faces when joining the shells together.

Gaskets can be utilized in various manners. In one embodiment, an adhesive gasket is placed along all interfaces between the shells, creating a gasket-to-gasket interface. These gaskets can be further greased, for example, with a vacuum grease to improve the seal. The outer shell can have a hole for receiving a locating pin or bolt captive on the inner shell or frame, with the pin or bolt able to be tighten to a predetermined degree of gasket compression. In another embodiment or further manner, the shells and/or frames can be removably connected with a cam clamping device or U clamp.

In another embodiment, an inflatable gasket can be utilized to form a seal between the shells. This inflatable gasket can be connected to a compressor and reservoir. In a further aspect, the gasket can be connected with a programmable controller that triggers an alarm when a pressure loss of a predetermined amount occurs.

In a second shell design embodiment, rather than gaskets, heavy plate sections can be used to form mating surfaces. The shells can have locating pins and orifices that allow for back-to-back and side-to-side configurations (e.g., the left half of the shell has pins and the right side has orifices designed for correct alignment). The pins guide and maintain the correct alignment of the shells while they are clamped together. In this embodiment, flanges can be slotted, with captive bolts located using the pin locators and compressed until spacers meet, for example, by use of a ratchet spanner.

The shells can include one or more glove ports for enabling an operator to access equipment and other items within the isolated environment. The shell can further include a window for viewing inside the containment system during operation. The glove ports can be on a panel permanently fixed to the shell, or on a panel that opens in a hinged fashion, such as a gull-wing panel or hinged panel that opens to the left, right or downwardly.

At least one shell preferably includes a supply air or gas (e.g., nitrogen) module for supplying air or gas to the interior of the containment system, thereby creating a pressure differential between the interior of the isolator and the exterior environment. The supply module preferably includes a high-efficiency particulate air ('HEPA') filter (e.g., a 99.97% HEPA filter, push push type) for particulate separation into the isolator. The supply module can further be equipped with a cut-off valve for preventing air or gas flow into the isolator.

At least one shell preferably includes an exhaust air or gas module for removing air or gas from the interior of the containment system. The exhaust module preferably includes a HEPA filter for capture of any contaminants, particulates or dust in the isolator that may occur when handling highly active products within the isolator. Like the supply module, the exhaust module can include a cut-off valve for controlling air or gas flow.

The shell can further include one or more pressure gauges for measuring pressure in the isolator, as well as the pressure differential across the supply and/or exhaust modules. The shell can include, for example, O₂ gauges for detection oxygen when an inert environment is required. Further, the shell can include one or more light modules (e.g., LED's) for illuminating the interior of the isolator.

The shell can also include a rail system for loading tables and/or process equipment such as presses into the isolator.

In addition to the shells, the modular containment system of the present invention can include one or more panels for enclosing the back and/or ends of the shells. A frame can be provided for connecting shells to another shell in back-to-back and/or side-to-side fashion, as well as connecting the panel to the shell. The frames can further be designed to allow for double-sided to single-sided configuration. This can be accomplished, for example, by a post and mounting rail.

The panel can include one or more glove ports. The panel can also include a window for viewing inside the configured containment system. Further, the panel can include a bagging ring for bagging product from the isolator.

At least part of the containment system can be mobile, for example, on wheels such as casters. The isolator can further include leveling jacks for leveling it on the process floor. Other portions of the containment system can be fixed in location.

In addition to the shells and panels, the present containment system can include one or more air handling units. Multiple air units allow for multiple isolator configurations to run at one time. In one embodiment, an air handling unit serves a single shell configuration having an interior space of, for example, about one cubic meter (about 36 cubic feet). In another embodiment, an air handling unit serves four shells in a double back-to-back configuration having an interior space of, for example, about 5 cubic meters (about 175 cubic feet). The air handling unit can be mounted on the containment system or on a wall.

In a further embodiment, the containment system contains one or more control panels. The control panel can provide a variety of functions, such as a rotimeter and valve for nitrogen supply to the containment system, an oxygen sensor for monitoring oxygen in the containment system and alarming when the oxygen value is out of range, switches for turning on and off lights within the containment system, and status indicators (e.g., for pressure, oxygen, etc.). The control panel can further include a pressure controller for setting pressure over a range (e.g., −25 pa to −100 pa). This can include alarm functions for over and under pressure.

Process equipment can be loaded into the containment system, for example, by fork lift or winch lift. Examples of process equipment include a piccolo press, blender, roller compactor, Fitz mill and jet mill. The process equipment can be placed on a wheeled table for running on tracks located on the floor of the shell. The table can be adjusted to the height required for operational processing within the shell. Process equipment can also be mounted on a plate such as a double-sided end plate, or on a baffle plate.

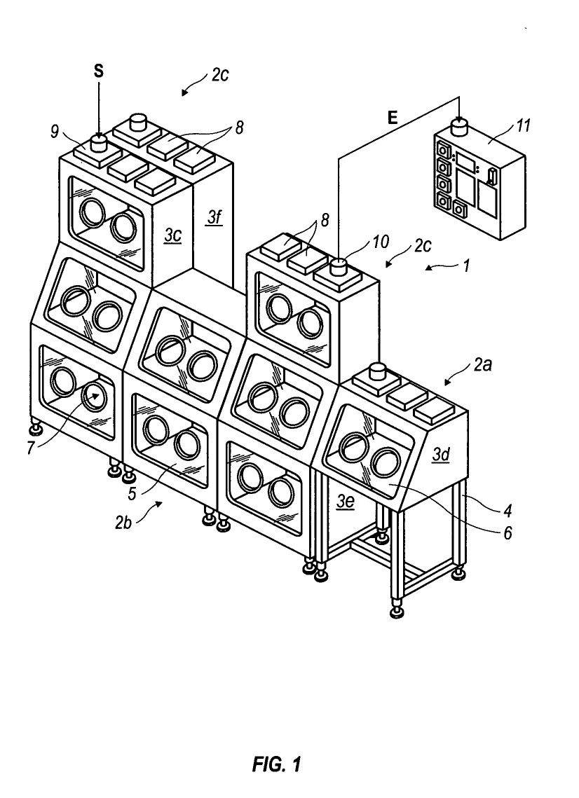

The modular containment system is further described with reference to the Figures. FIG. 1 illustrates a one embodiment of a modular containment system 1 according to the present invention.

Referring to FIG. 1, therein is illustrated an isolator or modular containment system 1 comprised of four shells connected in side-by-side fashion. The modular containment system 1 includes a single height shell 2a, a double height shell 2b and two triple height shells 2c. Three of the shells are single sided, while one of the triple height shells 2c is double sided. The triple height, double sided shell further includes a double sided end panel (not seen), a third level single sided end panel 3c and a triple height single sided end panel 3f. These single sided end panels can be either right or left handed, with end panels 3c and 3f illustrating right handed panels.

Referring to the single height shell 2a, it includes a right handed end panel 3d and rests on a support frame. Each of the shells further includes a fixed and/or operable access panel 5. The access panel 5, when operable, can open in any of a variety of methods. For example, the middle access panel 5 on each of the shells 2 could open in a gull-wing fashion, while the lower access panel could open downwardly like an oven door, or from either one of the sides like a door. The access panels 5 can be glazed with, for example, Lexan or toughened and laminated or laminated safety glass 6. The access panels 5 can further include one or more glove ports 7 for enabling an operator to access isolated equipment or product while avoiding contamination.

Each of the shells can optionally include one or more lights 8, which can be, for example, LED's. The lights preferably include a fixed glaze panel to the chamber of the containment system 1 in order to prevent contamination of the light filling.

The containment system 1 further preferably includes at least one air supply module 9 positioned on one of the shells and an air exhaust module 10 positioned, for example, on the same shell 2 (if a single shell containment system is utilized) or another shell 2 (if a multi-shell system is utilized). Obviously, if the containment system 1 is a large multi-shell system, it is possible that at least one of the shells contains neither module or contains either a supply or an exhaust module that is not required and valved off. The air supply module 9 preferably includes a pre-filter for filtering air into the chamber of the containment system 1 and a gas-tight close-off valve. Likewise, the air exhaust module 10 preferably includes at least one exhaust filter and gas-tight close-off valve.

The air supply 9 and exhaust 10 modules can be connected to an air handling module 11. This air handling module can further include a controller for controlling air pressure within the containment system 1. The controller should preferably be able to measure differential pressure and modify blower pressure to match a predetermined set pressure. This can occur, for example, by employing a variable frequency drive for modifying air flow output. The air handling module 11 can further include, for example, an on/off switch for the blower, one or more alarms for an out-of-range pressure and/or oxygen level, an oxygen monitoring alarm and equipment power shut off if out of range, and valve (e.g., rotimeter) for nitrogen supply (when the supply side valves are closed) and umbilical line to a low level injector.

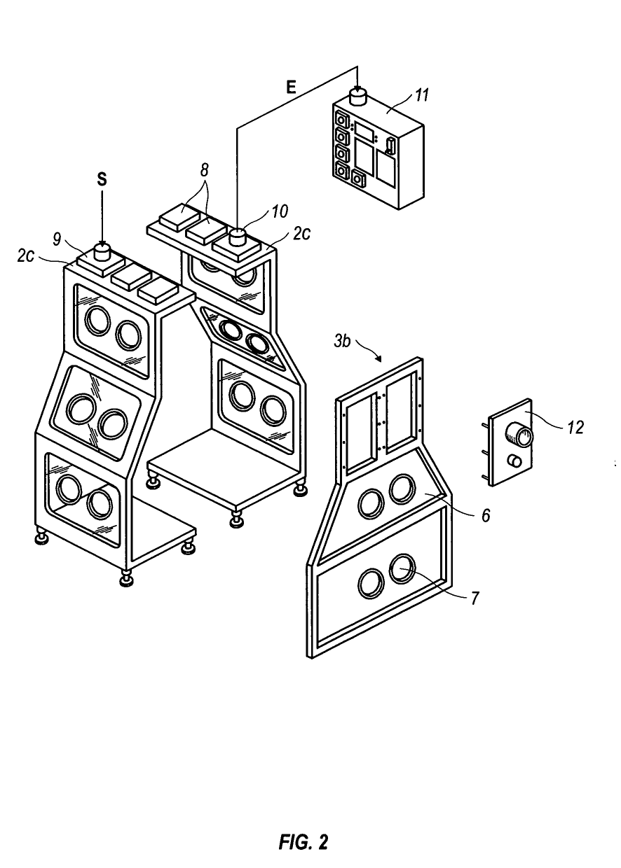

FIG. 2 further illustrates another embodiment comprising two triple height shells 2c joined back-to-back. In order to enclose the system, two double-sided end panels 3b are provided. These end panels 3b can optionally include one or more safety glass 6 and glove ports 7 for accessing product and/or process equipment isolated within the system 1. The end panels can further include an adaptable plate 12 provided with any appropriate transfer, pass through utility bulk head fitting. The adaptable plate can contain, for example, bagging rings, vacuum receiver and filters, utility connections, and so forth. The adaptable plate 12 is able to sealingly engage with the end panel 2c, for example, using universally interchangeable chamfered plated studs and acorn nuts together with gasket for sealing and spacers for maintaining a standard compression on the gasket.

Referring to FIG. 3, therein is illustrated a single height, single sided shell 2a on a support frame 7. For a single sided containment system 1, the back side of the shell 2 is enclosed with a baffle plate 14 secured to the shell 2 by a frame 13. Obviously, depending upon the height of the shell 2, the frame 13 and baffle plate 14 can be of such size as to enclose the back side of the shell 2, whether it is, for example, single height 2a, double height 2b, or triple height 2c. Further, a multi-height shell 2 can have a single frame 13 and one or more baffle plates 14 mounted thereon. For example, there can be a lower or bottom baffle plate 14 corresponding to the lower glove section of the shell 2 and an upper baffle plate 14 corresponding to the upper glove section(s) of the shell 2. The baffle plate can further be fitted for mounting equipment thereon and/or with pass in/pass out devices (e.g., bagging rings, etc.). Understandably, the size of the equipment mounted onto the plate 14 can affect the size of the plate 14. For example, some equipment can be mounted on an upper and mid baffle plate 14, whereas larger equipment such as a roller compacter may need to be mounted on a combined, single upper, mid and lower baffle plate. As illustrated in FIG. 4, the width of the baffle plate 14 and frame 3 can vary to accommodate more than one shell 2 joined side-by-side. Such an arrangement allows mounting of equipment or equipment trains that may be too wide for a single shell 2. Non-limiting examples of these combinations are further illustrated in FIGS. 5 and 6, wherein FIG. 5 illustrates a single sided, triple height shell 2c and single frame 13 for mounting three baffle plates 14 onto the back side of the shell 2c. FIG. 6 illustrates a single frame 13 and baffle plate 14 for enclosing the back side of two triple height shells 2c. Both systems 1 would require two triple height, single sided end panels 3f for completing the enclosure.

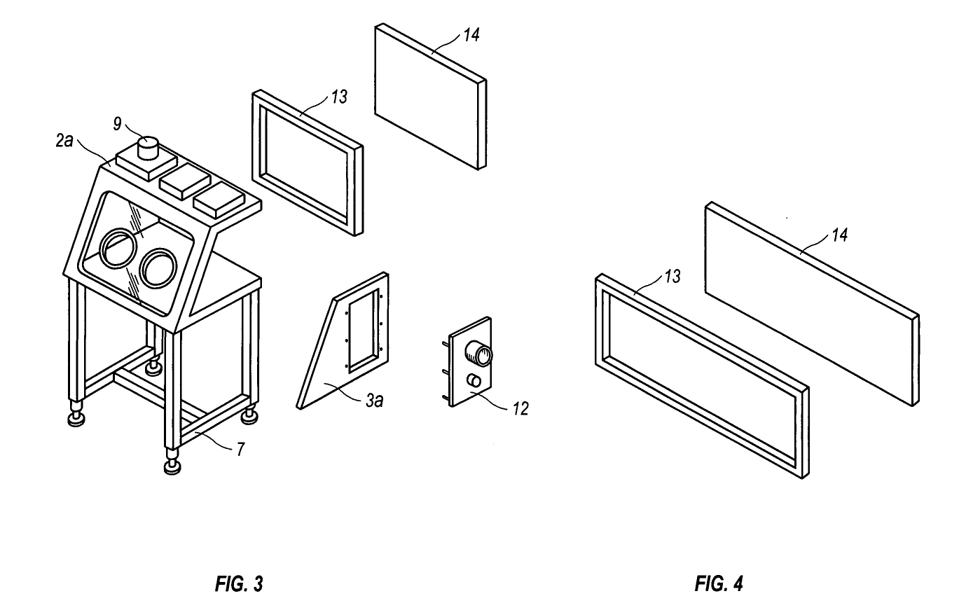

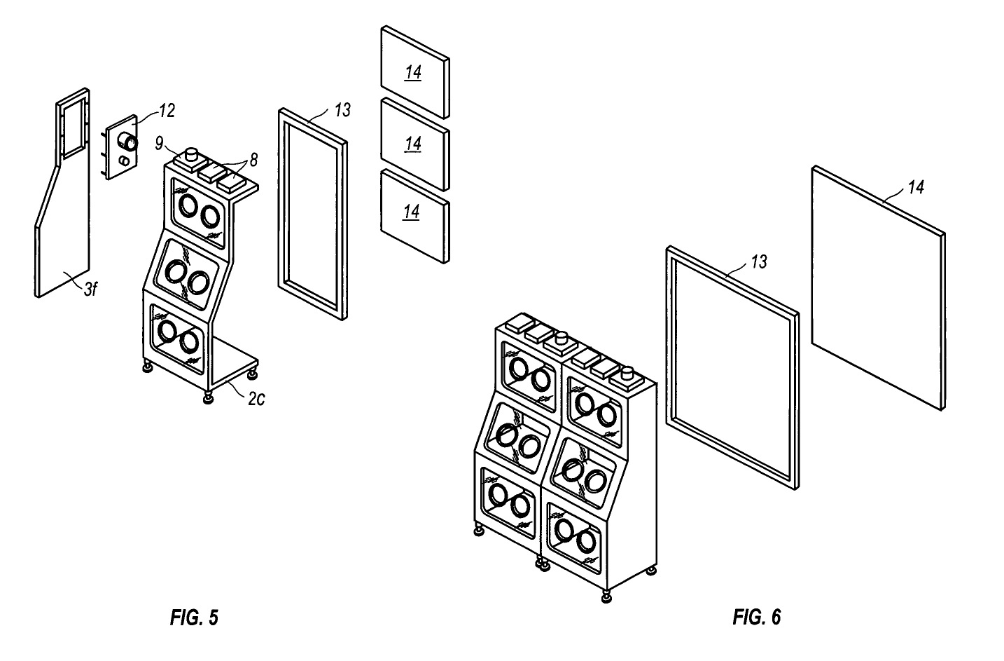

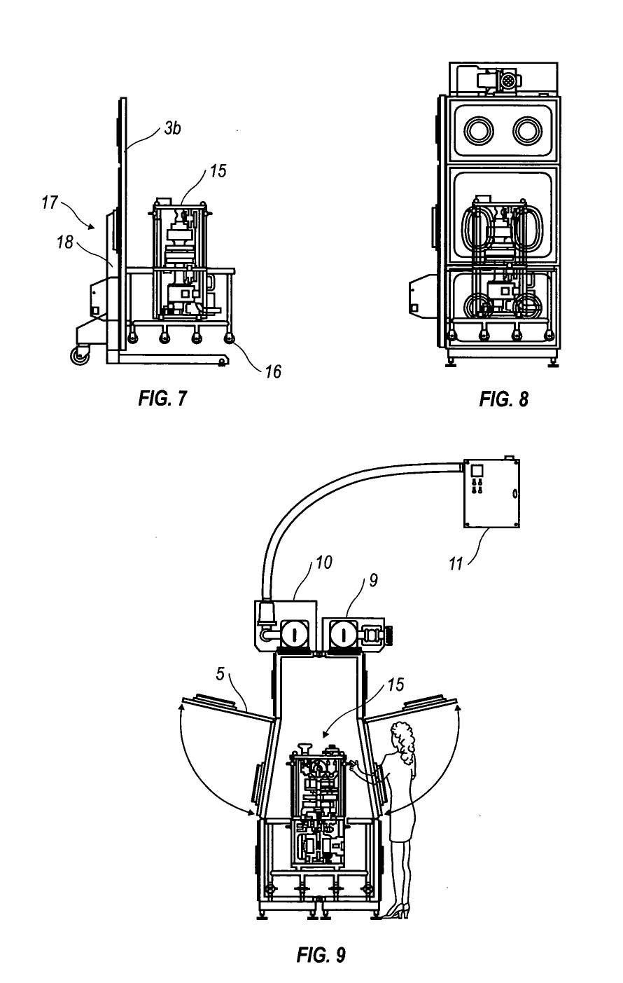

FIG. 7 illustrates a method of loading equipment into a containment system 1. Here, a piccola press 15 is mounted on a cart 17, allowing it to be placed inside triple height, back-to-back shells 2. The press 15 is attached to a double sided end panel 3b for placement in the containment system 1. The press 15 can have casters or wheels 16 for rolling the press 15 into the shells 2. The shells 2 can be equipped with rails for engaging the wheels 16 in the chamber, thereby providing a stable support for the press 15 in the chamber. The cart 17 can further include structural posts 18 for supporting the end panel 3b, as well as forming a structural connection to outriders. The cart 17 can also have electric controllers for loading and removing the press, as well as castors, preferable heavy duty.

FIG. 8 is a front view of an isolator 1 with a press 15 mounted therein. FIG. 9 further illustrates this from a side view with the end panel 3 removed. This view further illustrates gull wing access doors 5, as well as an operator accessing the press 15 through a glove port 7.

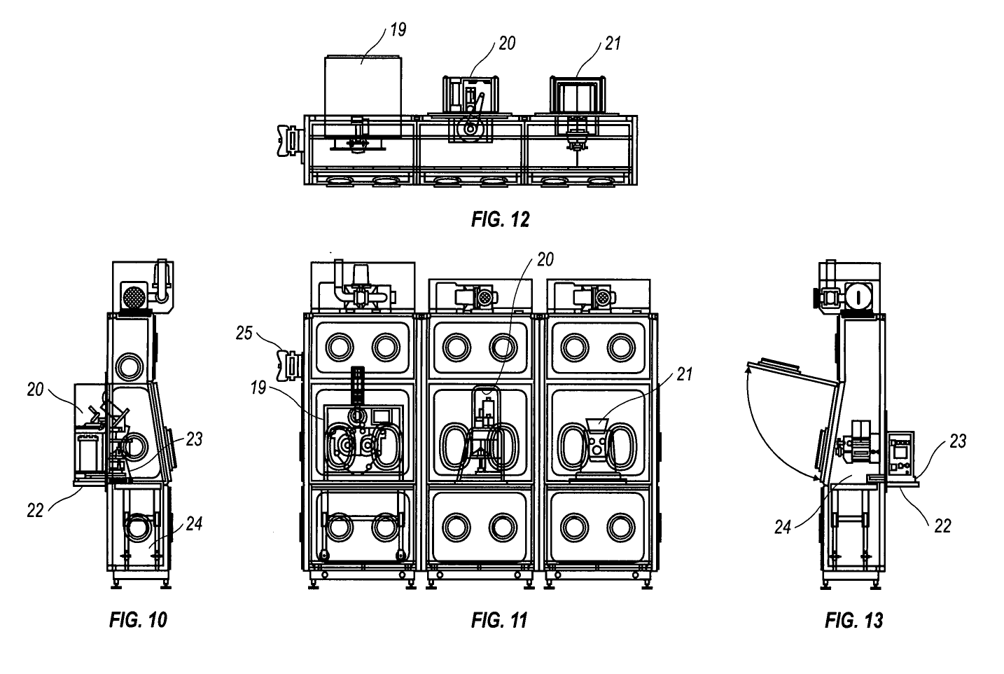

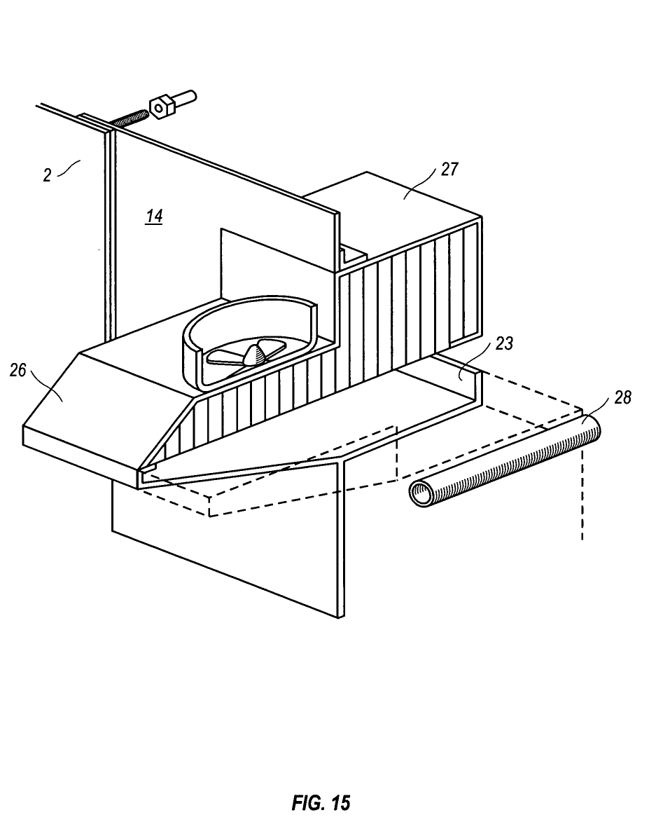

FIGS. 10 through 13 illustrate another embodiment of a containment system 1 with equipment mounted therein. Here, three single sided, triple height shells are connected in a side-by-side arrangement with a chilsonator 19, key granulator 20 and mill 21 contained therein. The equipment is mounted on one or more baffle plates 14, which are secured to the shells 2 by the frames 13. The baffle plates 14 can be rack mounted for storage when not in use. The plates 14 can further include a shelf 22 with tubular end parts whereby an operator can move, place and rack the baffle plate 14. The containment system 1 can further include one or more ventilated shelves 23 whereby a motor running equipment in the isolator 1 can vent to the outside (also illustrated in FIG. 15). The equipment can further optionally be mounted on a trolley 24 or the trolley 24 be used for material staging and handling, with the trolley optionally being adjustable in height.

FIG. 11 further illustrates a bagging ring 25 attached to an adaptable plate. The bagging ring 25 enables an operator to pass material in and out of the chamber of the containment system 1.

FIG. 15 further illustrates an embodiment for housing process equipment in a containment system 1. The equipment is mounted onto a baffle plate 14 and the baffle plate 14 secured to the shell 2. When securing the plate 14 to the frame 13, preferably a seal such as a gasket is provided between the plate 14 and shell 2 and/or frame 13 to insure that pressure is maintained within the system 1. The frame 13 can further be equipped with connections rods for aligning the baffle plate 14 for mounting. At least some of these connection rods can be adapted for securing the plate 14 onto the frame 13.

The equipment is further placed on a ventilated shelf 23, which is vented to the exterior of the containment system 1. The shelf 23 can be formed on the baffle plate 14 or separate therefrom.

The housed equipment and/or baffle plate 14 can further be mounted on tubular legs 28 for mounting the plate 14 onto the frame 13 and for storing the plate 14 and/or equipment.

The housing includes both an interior housing portion 26 and an exterior housing portion 27. The connection between the interior housing 26 and the shelf 23 is preferably sealed, such as with a silicone seal.

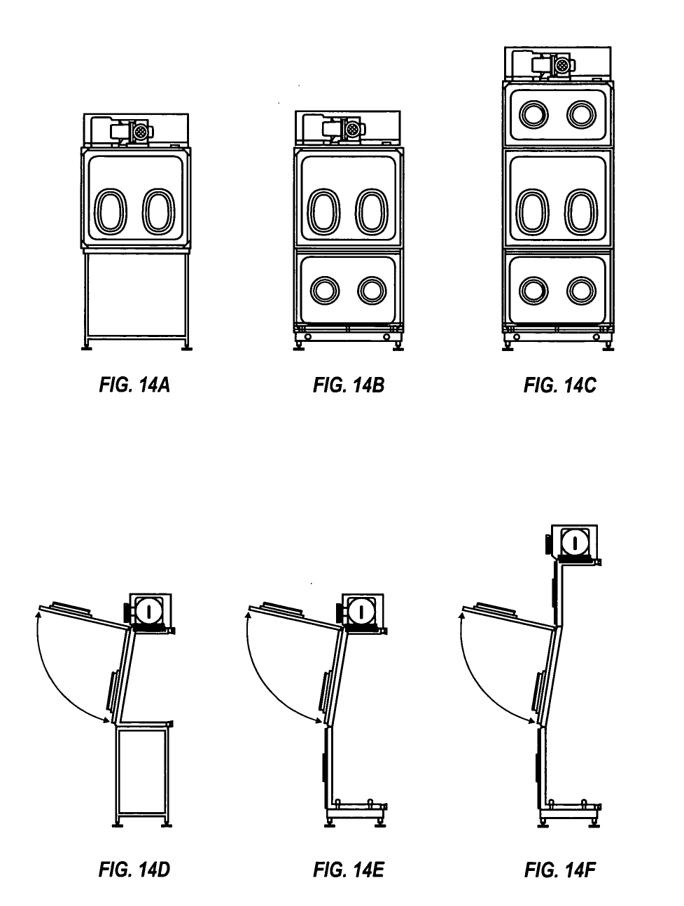

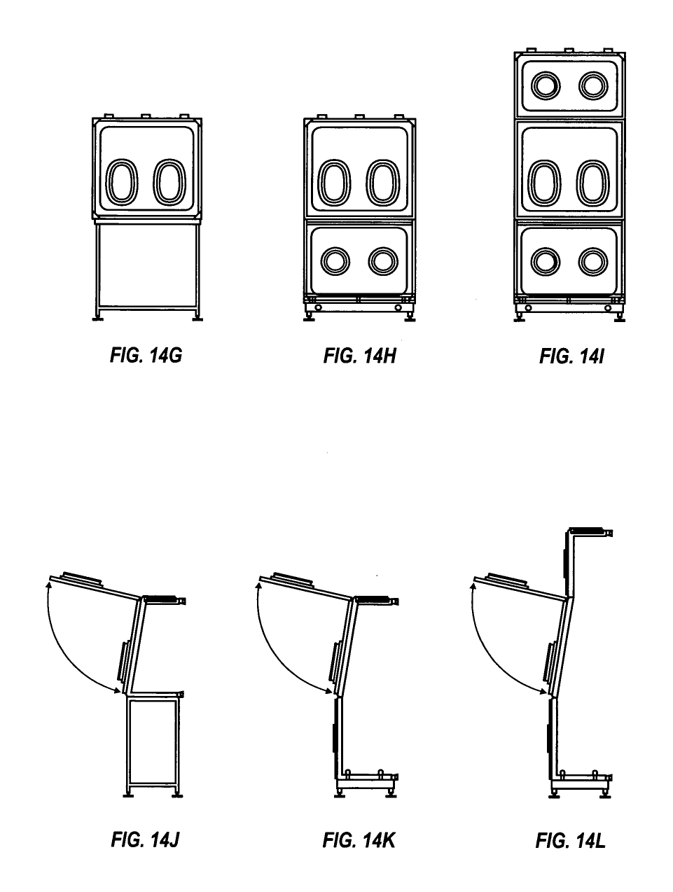

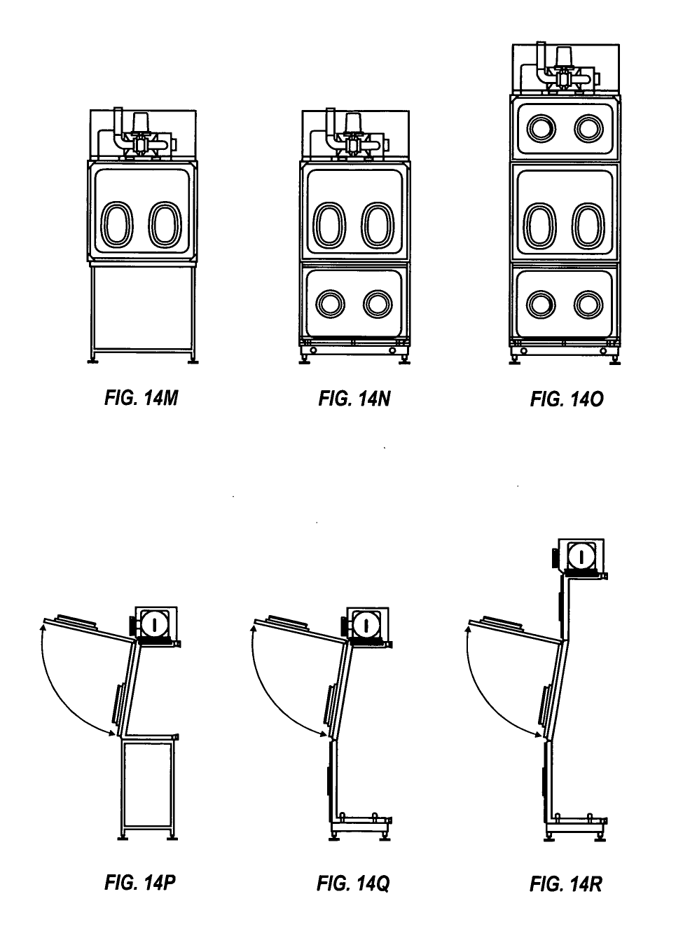

FIG. 14 A-S is a series of various embodiments of the shells 2 according to the invention from both front and side plan views.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

We claim:

1. Modular containment system comprising:
at least two shells having at least one shell panel whereby an operator is able to manipulate equipment contained in a isolated environment, and
at least two end panels, or
at least one shell having at least one shell panel whereby an operator is able to manipulate equipment contained in a isolated environment and at least one plate, and
at least two end panels,
wherein the at least two shells and at least two end panels, or the at least one shell, at least one plate and at least two end panels are able to be configurably and removably connected together,
wherein when the at least two shells and at least two end panels, or at least one shell, at least one plate and at least two end panels are connected together, form a closed housing wherein a pressure differential can be created between the inside of the housing and outside the housing, thereby forming an isolated process environment.

2. Modular containment system according to claim 1 further comprising a frame and at least one baffle plate able to be configurably and removably connected to the at least one shell and at least one end panel, wherein the at least one baffle plate is able to be configured with process equipment thereon for use within the isolated process environment.

3. Modular containment system according to claim 1, wherein the shell panel further comprises one or more glove ports.

4. Modular containment system according to claim 1 further comprising an air handling module for regulating pressure within the modular containment system, thereby creating the pressure differential.

5. Modular containment system according to claim 1 wherein pressure inside the closed housing is from about −50 pa to about 200 pa.

6. Modular containment system according to claim 1 wherein the at least one shell and at least one end panel can be single, double or triple height, wherein each height can have a panel for manipulating equipment within the isolated process environment.

7. Modular containment system according to claim 1 wherein the at least one shell can be removably connected to a second at least one shell in a side-by-side arrangement.

8. Modular containment system according to claim 7 wherein the at least one shell can be removably connected to a second at least one shell in a side-by-side arrangement, and the shells can be of the same height or of differing heights.

9. Modular containment system according to claim 1 wherein the at least one shell can be connected to a second at least one shell in an end-to-end arrangement, thereby forming a double-sided isolator.

10. Modular containment system according to claim 9 wherein the double-sided isolator is a single, double or triple height isolator.

11. Modular containment system according to claim 1 wherein the containment system is able to handle Class II dusts.

12. Modular containment system according to claim 11 wherein the containment system is able to provide a nitrogen inert environment.

13. Modular containment system according to claim 1 wherein the containment system can be removably and air sealably connected to any isolator having a connectable interface.

14. Modular containment system according to claim 1 wherein the at least one end panel further comprises one or more glove ports.

15. Modular containment system according to claim 1 wherein the at least one end panel further comprises process equipment mounted thereon.
